(19) United States
(12) Patent Application Publication
(10) Pub. No.: US 2007/0187298 A1
(43) Pub. Date: Aug. 16, 2007

(54) VEHICLE WHEEL, IN PARTICULAR FOR CYCLES

(75) Inventor: Pietro PERLO, Orbassano (IT)

Correspondence Address: SUGHRUE MION, PLLC, 2100 PENNSYLVANIA AVENUE, N.W., SUITE 800, WASHINGTON, DC, 20037, US

(73) Assignee: C.R.F. SOCIETA CONSORTILE PER AZIONI, Orbassano (IT)

(21) Appl. No.: 11/673,804

(22) Filed: Feb. 12, 2007

(30) Foreign Application Priority Data
Feb. 15, 2006 (EP) 06425089.7

(51) Int. Cl. B60C 11/11; B60C 7/00; B60B 19/00

(52) U.S. Cl. 209/1; 152/209.26

(57) ABSTRACT

The wheel comprises a rim connected to a central hub, and an annular tread structure mounted about the rim and adapted in use to bear and revolve on the ground or other surface on which the vehicle is moving. The tread structure comprises a self-supporting profiled member of annular shape made from a substantially rigid material and having an arch-shaped hollow section with a convex outer surface with which a plurality of discrete, radially projecting, bearing formations is connected and adapted to engage the ground or other surface.

The present invention relates to a vehicle wheel, and in particular to a wheel for cycles.

The invention relates more particularly to a wheel comprising
a rim connected to a central hub, and
an annular tread structure mounted about the rim and adapted in use to bear and revolve on the ground or other surface on which the vehicle is moving.

In the wheels used at present for road vehicles and in particular for cycles, the annular tread structure comprises a tyre of vulcanised elastomer material which may be reinforced but is unable, however, to support the vehicle on its own, and an annular air chamber inserted in the tyre and adapted to stabilise its shape and to form therewith a bearing structure able to support the vehicle when stationary and when moving.

The contact surface with the ground (the so-called “imprint”) of these wheels is relatively large even when the vehicle is bearing a low load. Although this helps, on the one hand, to ensure good ground-holding, the resulting high ground friction, on the other hand, entails substantial resistance to forward movement. In order to reduce the rolling friction and to increase ground-holding in the case of rain, the tyre is normally provided with surface scoring, but both friction and skidding continue to be major problems.

An object of the present invention is to provide a vehicle wheel, in particular for cycles, which has a reduced contact surface with the ground or other surface on which the vehicle is moving.

These and other objects are achieved by the invention which relates to a wheel of the type described above, characterised in that the tread structure comprises a self-supporting profiled member of annular shape made from a substantially rigid material and having an arch-shaped hollow section with a convex outer surface with which a plurality of discrete, radially projecting, bearing formations is connected and adapted to engage the ground or other surface on which the vehicle is moving. The number of projecting surfaces in contact with the ground and the transverse distance between the two end surfaces depend on the planned load on the vehicle.

In an embodiment, the annular self-supporting profiled member is advantageously made from metal material, preferably from steel.

This self-supporting profiled member is advantageously provided on an outer surface with a plurality of discrete bearing formations made from an elastomer material having a high resistance to wear obtained by using a composite elastomer in which resistance to wear caused by rolling is ensured by ceramic, metal or alloy micro- or nanoparticles. These bearing formations may be formed by annular members which are spaced about the whole outer surface of the self-supporting profiled member. The bearing formations may also be formed by a plurality of projecting “spots” which are circular or of another geometry and have a bearing area for instance of between 1 square millimetre and 16 square millimetres.

Further characteristic features and advantages of the invention are set out in the following detailed description, given purely by way of non-limiting example, and made with reference to the accompanying drawings, in which:

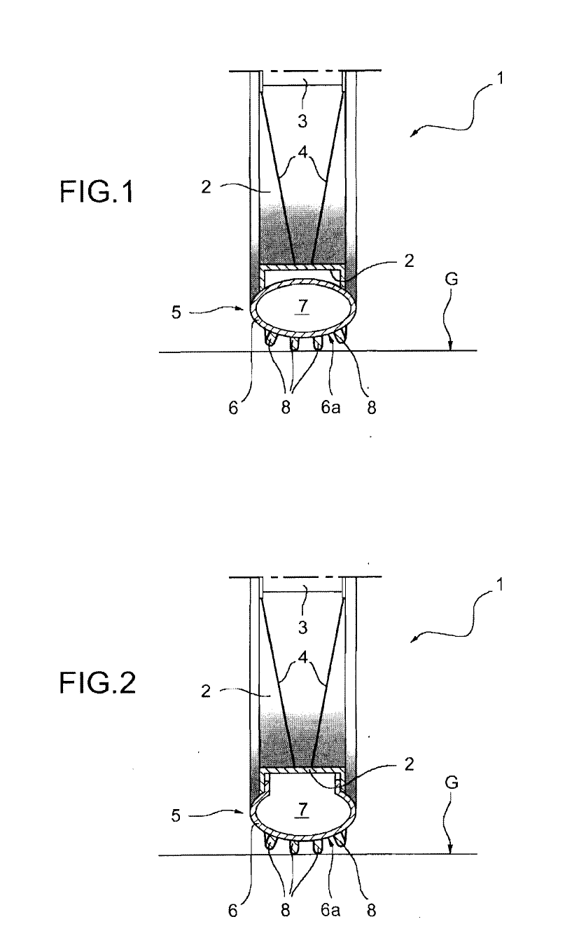

FIG. 1 is a partial view in axial section of a vehicle wheel, in particular for cycles, of the present invention;

FIG. 2 is a partial view in axial section of a variant of a wheel of the invention.

In the drawings, a vehicle wheel of the present invention, in particular for cycles, is shown overall by 1.

In the present description and in the accompanying claims, the term “cycles” is not limited solely to bicycles but generally covers other types of cycle, for instance power-assisted bicycles, motorcycles, etc.

With reference to FIG. 1 in particular, the wheel 1 shown therein comprises a rim 2, made for instance from a light metal alloy or from a plastics or composite material, connected to a central hub 3, for instance by spokes 4. The rim 2 could nevertheless be connected to the hub 3 in a different manner, for instance by half-shells adapted overall to form a structure of lenticular shape or a disc, etc.

In the embodiment shown by way of example, the rim 2 has a section of square C shape. This shape is merely given by way of example and is in no way limiting.

An annular tread structure, shown overall by 5, is mounted about the rim 2. This structure is adapted in use to bear and to revolve on the ground G or other surface on which the vehicle to which the wheel 1 belongs is moving. This structure has a function equivalent to that played by conventional tyres with air chambers or tubular tyres in conventional wheels.

In the embodiment shown in FIG. 1, the tread structure 5 comprises a self-supporting profiled member 6 of annular shape made from a substantially rigid material such as laminated or extruded steel, in particular spring steel.

The self-supporting profiled member of FIG. 1 has a hollow elliptical section with its convex outer surface 6a facing the ground G.

The annular profiled member 6 is self-supporting in the sense that its shape is intrinsically stable and does not require an air chamber. The region 7 within this self-supporting profiled member may be empty or filled with air. As an alternative, this region 7 may be filled with a polymer material, for instance a polyurethane or an elastomer whose purpose is to protect the interior of the profiled member 6 against moisture and, though its own elasticity, to help to prevent the profiled member 6 from bending beyond its own elastic limit so that it is permanently deformed.

Although the material, such as steel, from which the self-supporting profiled member 6 is made is substantially rigid per se, this self-supporting profiled member has a degree of elastic deformability as a result of its shape. The lower diameter of the section of the profiled member 6 may therefore be substantially reduced, for instance by some 10-25%, as a result of the load bearing on it when it is in use, and the greater diameter of this section may be correspondingly increased.

The outer surface 6a of the self-supporting profiled member 6 is connected to a plurality of discrete, radially projecting, bearing formations 8 adapted to contact the ground G.

In the embodiment shown in FIGS. 1 and 2, the bearing formations 8 are in the form of rings which are transversely spaced from one another about the whole periphery of the outer surface 6a of the self-supporting member 6. Other embodiments are nevertheless possible, such as the provision of discrete “spots”.

The bearing formations 8 are advantageously made from an elastomer material having a high resistance to wear, preferably in composite form with the inclusion of ceramic, metal or alloy micro- or nanoparticles.

The bearing formations 8 may be attached to the outer surface of the self-supporting member 6 using various known techniques, for instance adhesion, engagement in seats provided in the outer surface of the self-supporting member, duplicate moulding, etc.

The arrangement of the bearing formations is preferably such that direct contact between the self-supporting profiled member 6 and the ground G is avoided, even in operating conditions in which the wheel 1 is in an inclined position with respect to the ground.

The self-supporting profiled member 6 of closed section of the wheel of FIG. 1 may be produced in various known ways, for instance by welding of two half-rings of semi-elliptical section, which half-rings may be made from a strip of flexible spring steel of appropriate thickness. In a further embodiment, the annular profiled member may be extruded and then bent to form a rim whose ends are then welded together. In this embodiment, the member 6 may be completely independent from the wheel 1 and applied thereto in its final form as is conventionally the case with the conventional air chamber and tyre system. In this case, the rim 2 of the wheel may advantageously be provided with pressure hooks adapted to make the installation or replacement of the profiled member 6 rapid and simple.

FIG. 2 shows a variant of the wheel of the invention. In this Figure, parts and components already described bear the same reference numerals as used previously.

In the variant of FIG. 2, the annular tread structure 5 comprises an annular self-supporting profiled member 6 of open transverse section, substantially in the shape of a C, whose end members are connected to the rim 2.

In this case as well, the region 7 within the self-supporting profiled member 6 may be filled with air or filled, for instance, with a polymer or elastomer material.

The self-supporting profiled member 6 of FIG. 2 is provided with a plurality of discrete, radially projecting, bearing formations 8 in relation to which the preceding description applies.

The wheel of the invention has a limited contact surface with the ground G as this contact takes place solely at the location of the projecting bearing formations 8. This makes it possible substantially to reduce the resistance to travel. The transverse distance between the end points of contact of these formations with the ground is nevertheless such as to ensure the maximum stability of the vehicle.

It will be appreciated that, without prejudice to the principle of the invention, the embodiments and details thereof may be widely varied with respect to what has been described and illustrated purely by way of non-limiting example, without thereby departing from the scope of the accompanying claims.

What is claimed is:

1. A vehicle wheel, in particular for cycles, comprising
a rim connected to a central hub, and
an annular tread structure mounted about the rim and adapted in use to bear and revolve on the ground or other surface on which the vehicle is moving,
the wheel being characterised in that the tread structure comprises a self-supporting profiled member of annular shape made from a substantially rigid material and having an arch-shaped hollow section with a convex outer surface with which a plurality of discrete, radially projecting, bearing formations is connected and adapted to engage the ground or other surface.

2. A wheel as claimed in claim 1, wherein the self-supporting profiled member has a closed transverse section.

3. A wheel as claimed in claim 1, wherein the self-supporting profiled member has an open transverse section.

4. A wheel as claimed in claim 1, wherein the self-supporting profiled member is made from a metal or plastics or composite material.

5. A wheel as claimed in claim 4, wherein the self-supporting profiled member is made from steel.

6. A wheel as claimed in claim 1, wherein the bearing formations are made from an elastomer or composite material with possible inclusions of ceramic, metal or alloy micro-and/or nanoparticles.

7. A wheel as claimed in claim 1, wherein at least some bearing formations are in the form of rings transversely spaced about the whole periphery of the outer surface of the self-supporting profiled member.

8. A wheel as claimed in claim 1, wherein at least some bearing formations are in the form of protruding spots with a bearing area preferably of between 1 square millimetre and 16 square millimetres.

9. A wheel as claimed in claim 1, wherein the bearing formations are glued to the self-supporting profiled member.

10. A wheel as claimed in claim 1, wherein the bearing formations are duplicate moulded on the self-supporting profiled member.

11. A wheel as claimed in claim 1, wherein the bearing formations are engaged in corresponding seats provided in the outer surface of the self-supporting profiled member.

12. A wheel as claimed in claim 1, wherein the rim is provided with retaining or hooking members adapted to enable the rapid insertion of the self-supporting profiled member.

13. A wheel as claimed in claim 1, wherein the profiled member is obtained from an extruded profiled member bent to form a rim whose ends are joined together.
